(19) United States
(12) Patent Application Publication
(10) Pub. No.: US 2022/0252767 A1
(43) Pub. Date: Aug. 11, 2022

(54) Rapid Aperture Adjustment Device

(71) Applicant: AETHER OPTICS, LLC, Pinehurst, NC (US)

(72) Inventors: Timothy Fuller, Pinehurst, NC (US); Kyle Winger, Fayetteville, NC (US)

(21) Appl. No.: 17/668,683

(22) Filed: Feb. 10, 2022

Related U.S. Application Data
(60) Provisional application No. 63/207,159, filed on Feb. 11, 2021.

(51) Int. Cl. G02B 5/00

(52) U.S. Cl. CPC G02B 5/005

(57) ABSTRACT

Night vision refocus devices are provided, in which the night vision refocus devices include a housing comprising (i) a proximate end configured to couple to a lens frame (e.g., housing an objective lens) of a night vision device and a distal end, (ii) a faceplate operably connected to the housing, in which the faceplate includes a faceplate aperture, and (iii) an aperture-selection component (ASC) rotatably mounted directly or indirectly to the faceplate. The ASC includes a plurality of individual refocusing-apertures (IFAs) including a first IFA having a first area and a second IFA having a second area, in which the first area is larger than the second area. The first IFA is aligned with the faceplate aperture when the ASC is oriented in a first position, and the second IFA is aligned with the faceplate aperture when the ASC is oriented in a second position.

### CROSS-REFERENCE TO RELATED APPLICATIONS

This application claims priority under 35 U.S.C. § 119(e) to U.S. Provisional Application No. 63/207,159, filed Feb. 11, 2021, which is expressly incorporated by reference herein in its entirety.

### TECHNICAL FIELD

Embodiments of the presently-disclosed invention relate generally to night vision refocus devices that provide rapid aperture adjustment by selection of one of a series of fixed apertures on a single device. Embodiments of the presently-disclosed invention also generally relate to night vision devices including one or more night vision refocus devices.

### BACKGROUND

Many optical devices come with built in aperture controls such as typically found on cameras and usually in the form of continuously variable apertures. There are also many devices which do not have built in aperture controls and yet for which it is desirable to adjust the aperture size and thus change the depth of focus. In this regard, there are currently two methods used involving accessory type attachments for this purpose. The first method uses a continuously variable aperture. This method, however, is not particularly desirable for certain applications in which multiple lines-of-sight are simultaneously required (e.g., simultaneous viewing from a right eye and a left eye of a user employing night vision goggles) since the likelihood and/or ease of matching two independent continuously variable apertures at the identical diameter is particularly difficult, especially in the field during an on-going activity. In this regard, the mismatching of two independent continuously variable apertures as part of a night vision device may lead to impaired vision or focus by the user as well as inducing eyestrain and/or initiating a headache for the user. The second method uses a single aperture having a fixed diameter. This approach, however, provides limited flexibility and may only be beneficial in a few lighting scenarios. Moreover, the substitution of one fixed diameter device or component with another fixed diameter device or component having a different diameter to better accommodate a particular lighting scenario and engagement distance is onerous and time-consuming, particularly when the user is in the field during an on-going activity.

In this regard, there remains a need in the art for a night vision refocus device that provides rapid adjustment between multiple fixed apertures on a single device.

### SUMMARY OF INVENTION

One or more embodiments of the invention may address one or more of the aforementioned problems. Certain embodiments according to the invention provide night vision refocus devices including a housing comprising a proximate end configured to couple to a lens frame of a night vision device and a distal end, and a faceplate operably connected to the housing, in which the faceplate includes an outer surface, an inner surface, and a faceplate-aperture having a faceplate-aperture area. The night vision refocus devices may also include an aperture-selection component (ASC) rotatably mounted directly or indirectly to the faceplate. The ASC may include a plurality of individual refocusing-apertures (IFAs) including a first IFA having a first area and a second IFA having a second area, in which the first area is larger than the second area. The first IFA may be aligned with the faceplate aperture when the ASC component is oriented in a first position, and the second IFA may be aligned with the faceplate aperture when the ASC is oriented in a second position.

In another aspect, the present invention provides an optical device, such as a night vision device, including a light-intensifying structure (e.g., an image intensifier or other device or structure that increases the intensity of available light in an optical system to allow use under lower-light conditions) and a night vision refocus device, such as those described and disclosed herein. The night vision refocus device may be permanently or releasably mounted to a lens frame (e.g., housing an objective lens) of the night vision device.

### BRIEF DESCRIPTION OF THE DRAWING(S)

The invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout, and wherein:

FIG. 1 illustrates a night vision refocus device having a faceplate in a closed state with an engageable portion extending beyond the faceplate and a housing of the night vision refocus device in accordance with certain example embodiments;

FIG. 2 illustrates a night vision refocus device having a faceplate in a closed state with an engageable portion extending beyond the faceplate and a housing of the night vision refocus device, and further illustrating the addition of an optional locking component in accordance with certain example embodiments;

FIG. 3 illustrates another isometric view of a night vision refocus device in a closed state illustrating alignment of a faceplate aperture and a first individual refocusing-aperture in accordance with certain example embodiments;

FIG. 4 illustrates a top view of a night vision refocus device having a faceplate in a closed state in accordance with certain example embodiments;

FIG. 5 illustrates a top view of a night vision refocus device having a faceplate in a closed state illustrating alignment of a faceplate aperture and a first individual refocusing-aperture in accordance with certain example embodiments;

FIG. 6 illustrates a night vision refocus device with a faceplate in an open state in accordance with certain example embodiments;

FIG. 7 illustrates another night vision refocus device with a faceplate in an open state in accordance with certain example embodiments;

FIG. 8 illustrate an inside surface of a faceplate in accordance with certain example embodiments;

FIG. 9 illustrates an aperture-selection component in accordance with certain example embodiments;

FIG. 10 illustrates an exploded view of a night vision refocus device in accordance with certain example embodiments;

FIG. 11 illustrates an exploded view of another night vision refocus device in accordance with certain example embodiments;

FIG. 12 illustrates a night vision device in accordance with certain example embodiments;

FIGS. 13A-F illustrates as worn clocking states of a night vision refocus device coupled to a lens frame of a night vision device, in which the engageable portion of the aperture-selection component is located in an outboard position in accordance with certain example embodiments;

FIGS. 14A-F illustrates as worn clocking states of a night vision refocus device coupled to a lens frame of a night vision device, in which the engageable portion of the aperture-selection component is located in an underside position in accordance with certain example embodiments.

### DETAILED DESCRIPTION

The invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. As used in the specification, and in the appended claims, the singular forms “a”, “an”, “the”, include plural referents unless the context clearly dictates otherwise.

The presently-disclosed invention relates generally to night vision refocus devices that provide rapid aperture adjustment by selection of one of a series of fixed apertures on a single device. Aperture reduction, within the context of night vision applications, increases depth of focus which is critical for near-focus applications such as reading maps, opening doors, setting charges, etc. Certain example embodiments, for instance, provide a comparative simplicity and lower cost than a continuously variable aperture configuration while allowing for a much faster and convenient method of changing the aperture than an accessory device having only a single aperture. In accordance with certain example embodiments, for example, the night vision refocus devices may utilize a method and/or configuration that allows aperture changes in a fixed stepped sequence rather than continuously variable, while providing this functionality in a single device that does not require removal and replacement of the device or a component to achieve multiple fixed apertures. Additionally or alternatively, the night vision refocus devices may also provide a hinged movement of an aperture-selection component (ASC), such as a rotating selector disc, and pivot point body in order to quickly remove the night vision refocus device from the optical device's line-of-sight and return the optical device's functionally to its unmodified state and will hinge back into position when desired. In this regard, for example, the night vision refocus device may be provided as an accessory that attaches securely to an objective lens (e.g., frame housing the objective lens) of an optical device that allows the user to rapidly select discrete (e.g., individual) repeatable channel-matched apertures (e.g., a right-side aperture of the refocus device is matched with a left-side aperture of another refocus device on a separate optical channel). Additionally or alternatively, the night vision refocus device may accommodate outboard and bottom of channel clocking states, as well as opening nearly flush to reduce snag hazards.

In accordance with certain example embodiments, the night vision refocus device attaches securely to the objective lens (e.g., or lens frame housing the objective lens) and allows the operator to rapidly and precisely select repeatable channel-matched apertures. The night vision refocus device may include an ASC in the form of a disc including multiple independent or discrete apertures (e.g., 2, 3, 4, or 5 each having a unique diameter or aperture area) to encompass a broad range of lighting scenarios. For example only, the ASC may include three (3) independent or discrete apertures including a small-area aperture, a medium-area aperture, and a large-area aperture. In accordance with certain example embodiments, the ASC may auto-align at each fixed position associated with a respective aperture to align the respective aperture with the line-of-sight of the optical device. In this regard, the user can easily flick or otherwise switch between aperture states (e.g., between the different sized apertures of the ASC) with a single one-handed motion in either direction. The ASC, for example, may be configured in such a manner so that the user can easily keep track of which aperture is engaged and thus maintain channel-matched focus (e.g., the aperture size of a left side component and the aperture size of the right side component when worn as a pair on a multi-channel optical device have an identical aperture diameter and/or area) and thus brightness throughout operation. In accordance with certain example embodiments, the night vision refocus device does not use a sacrificial lens, thus the optical clarity of the optical device (e.g., a night vision device) is not impacted.

In accordance with certain example embodiments, the night vision refocus device affixes to the objective lens (e.g., or lens frame housing the objective lens) such that after it is secured the night vision refocus device is prevented from accidentally sliding off the front of the objective lens. The attachment method, for example, may also permit a range of clocking states (e.g., relative orientation of the refocus device relative to the optical device), allowing the user to position the ASC according to their preferred ergonomics.

The night vision refocus device, in accordance with certain example embodiments, utilizes a rotating ASC (e.g., a disc) including a plurality of fixed apertures of various unique diameters (e.g., each aperture has its own unique diameter or open area). The ASC may be held by a faceplate with an offset pivot point (e.g., axis of rotation about an axle) about which the disc rotates such that each aperture is held in a desired fixed position relative to the sight line of an optical device and allows for rapid interchanging of the apertures to each of the fixed positions on the ASC. In certain example embodiments, the ASC may be manually operated (e.g., a rotating disc manually rotated by the user), in which the ASC includes one or more ASC-positioning elements (e.g., magnets, detents, or other methods of positioning methods) that mate with one or more faceplate-positioning elements (e.g., magnets, detents, or other methods of positioning) housed within or on the faceplate to position each selected aperture in, for example, a concentric alignment with the optical device (e.g., an objective lens) and a faceplate-aperture of the faceplate. As noted above, the night vision refocus device in accordance with certain example embodiments may utilize magnets to hold the ASC in the desired position. Additionally or alternatively, several other means of positioning the ASC about its pivot (e.g., axis of rotation) are contemplated, such as springs and detents, manual alignment, and/or friction at the axle passing through the ASC.

In accordance with certain example embodiments, the discrete or individual apertures of the ASC may comprise round or circular apertures concentrically located to the optical devices' line of sight. In alternative example embodiments, however, additional or other aperture shapes and non-concentric positions relative to the optical device may be utilized as possible desirable arrangements as well in order to achieve desired optical affects. Additionally or alternatively, the number of fixed aperture (e.g., discrete or individual apertures) on the ASC may not be particularly limited. For example, the number of fixed apertures of the ASC may comprise any number of fixed apertures for which there is physical space on the ASC. For example, enlarging the size of the ASC or changing the size of one or more apertures in the ASC may allow additional room for increasing the number of apertures on a single ASC. Additionally or alternatively, the night vision refocus device may include multiple ASC's, which would allow for additional aperture sizes and/or shapes. In accordance with certain example embodiments, the aperture sizes may be selected such that more apertures can be placed in the ASC. For example, the use of a series of apertures having a generally smaller area may enable the inclusion of more apertures placed in the ASC.

In accordance with certain example embodiments, the ASC may be manually operated by a user. In alternative example embodiments, however, additional or other possible operation modalities may be employed. For example, certain example embodiments may be configured for manual and/or automated selection of individual apertures based on light sensors and software, and/or the rotation of the ASC by means of electrical servos or other means.

Additionally or alternatively, the night vision refocus device may include a hinge that is utilized to allow the ASC and pivot point to be quickly removed from the optical device's sight line and return the optical device's functionality to its unmodified state. In this regard the hinge may operably couple the faceplate (and thus the ASC) to a housing that may be configured to attach to the optical device. The hinge, for example, may allow the ASC and the faceplate to be moved back into position when desired. In this regard, the faceplate may be provided in a closed state where the night vision refocus device is in use and an open state where the night vision refocus device is not being used (e.g., flipped or otherwise moved out of the sight line of the optical device). Although certain example embodiments utilize a hinge to swing the faceplate and ASC to and from the optical devices' line of sight, several other methods may also be employed in accordance with certain example embodiments to provide the same function, such as other style hinges, clips, magnets etc., which will provide a means to move the night vision refocus device off the line of sight of the optical device.

In certain example embodiments, the night vision refocus device may include a housing that utilizes a clamping structure or assembly to engage and to hold the night vision refocus device by means of friction and positive mechanical retention to the end of a known circular optical device or component thereof. Additionally or alternatively, other methods of attachment may be employed, such as magnets, screws, or other mechanical fasteners may be easily adapted according to the physical arrangement of individual optical devices. In such embodiments, the night vision refocus device may be considered as an accessory style device being adapted to existing optical devices. However, in accordance with certain example embodiments, the night vision refocus device may be incorporated into the optical device as a permanent feature.

In accordance with certain example embodiments, night vision refocus device may include a boss that interfaces with a knurling present on the objective lens and/or lens frame (e.g., housing an objective lens) and prevents the night vision refocus device from being removed from the front/distal end of the optical device (e.g., night vision device) while the clamp portion of the housing is fastened. In this regard, there may be multiple lens types and multiple types of knurling, thus the night vision refocus device may include a variety of bosses that interface with a respective type of knurling. Regardless, the boss may interface and catch on the knurling to prevent removal, and or rotation relative to the objective lens, and index on the face of the objective lens housing to limit how far the housing slides over the objective lens during installation. In this regard, the night vision refocus device may have a positive mechanical attachment to the night vision device. In accordance with certain example embodiments, the boss may be located on an inner surface of the housing of the night vision refocus device, such as a circumferential or axially aligned boss, or both simultaneously, positioned on the inside surface of the housing of the night vision refocus device such that sufficient mechanical attachment is achieved to prevent axial and or radial relative motion between the night vision refocus device and objective lens and/or lens frame (e.g., housing an objective lens).

As noted above, certain example embodiments according to the invention provide night vision refocus devices including a housing comprising a proximate end configured to couple to a lens frame of a night vision device and a distal end, and a faceplate operably connected to the housing, in which the faceplate includes an outer surface, an inner surface, and a faceplate-aperture having a faceplate-aperture area. The night vision refocus devices may also include an aperture-selection component (ASC) rotatably mounted directly or indirectly to the inner surface of the faceplate, the outer surface of the faceplate, or within a cavity defined by the faceplate. The ASC may include a plurality of individual refocusing-apertures (IFAs) including a first IFA having a first area and a second IFA having a second area, in which the first area is larger than the second area. The first IFA may be aligned with the faceplate aperture when the ASC component is oriented in a first position, and the second IFA may be aligned with the faceplate aperture when the ASC is oriented in a second position.

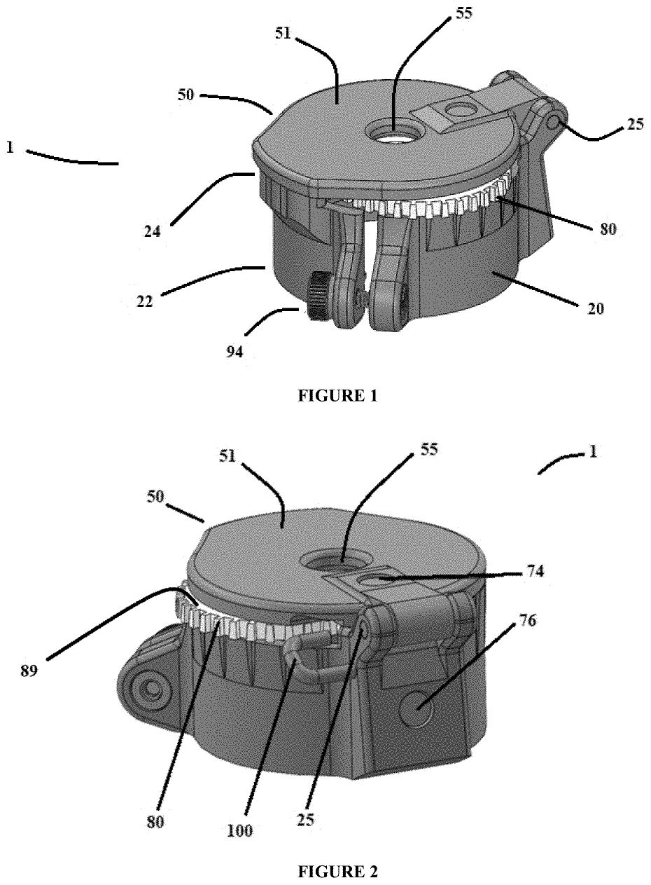

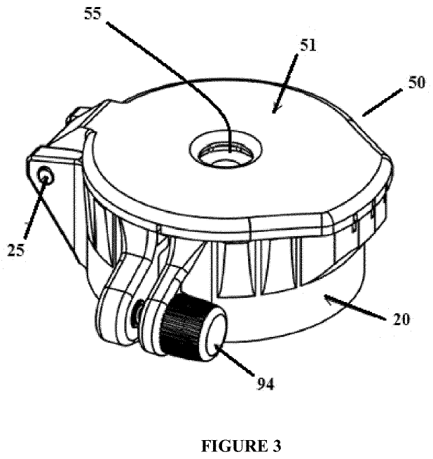

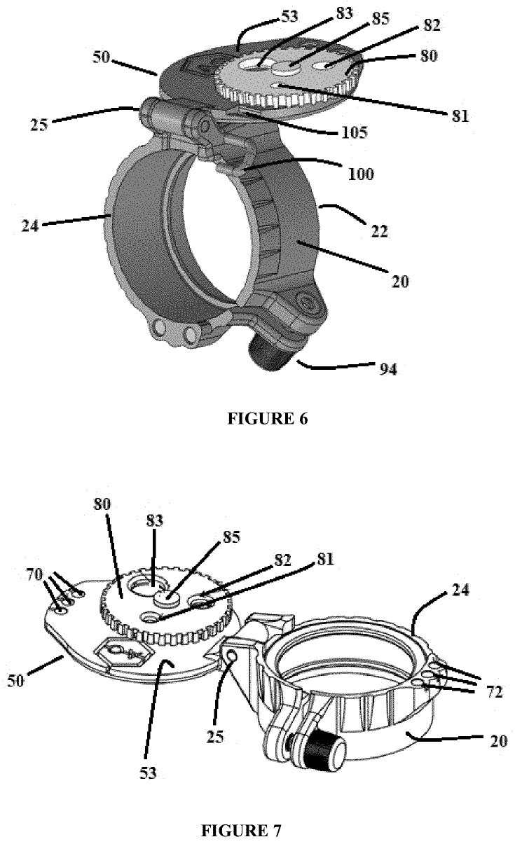

FIG. 1-3, for example, each illustrate a night vision refocus device 1. As illustrated in these figures, the night vision refocus device 1 includes a housing 20, a faceplate 50 including a faceplate-aperture 55, and an ASC 80 including an engageable portion 89 that extends beyond the faceplate and the housing. In this regard, the engageable portion 89 of the ASC extends beyond the faceplate 50 and housing 20 and is directly engageable by a user to impart rotation of the ASC, such as about the axle. Although FIGS. 1-3 illustrate an engageable portion 89 extending beyond the faceplate and housing, the ASC may additionally or alternatively be rotated by other means. In accordance with certain example embodiments, the housing includes a proximate end 22 configured to couple to a lens frame (or other component) of a night vision device and a distal end 24. The proximate end 22 of the housing 20 may include a fastening element, such as a clamp component 94. As shown in FIGS. 1-3, the night vision refocus device 1 may include a hinge 25 that connects the faceplate 50 to the housing 20, in which the faceplate may comprise a closed state as shown in FIGS. 1-3 and an open state as shown in FIGS. 6-7. The faceplate 50 includes an outer surface 51, an inner surface 53 (shown in FIGS. 6-8), and a faceplate-aperture 55.

As noted above and illustrated by FIGS. 1-3, the faceplate 50 may be coupled to or otherwise connected to the housing 20 via a hinge 25, in which the faceplate 50 has a closed state (as shown in FIGS. 1-3) in which the faceplate 50 is adjacent and/or overlies the distal end 24 of the housing 24 and an open state (as shown in FIG. 6-8) in which the faceplate 50 does not overlie the distal end 24 of the housing 20.

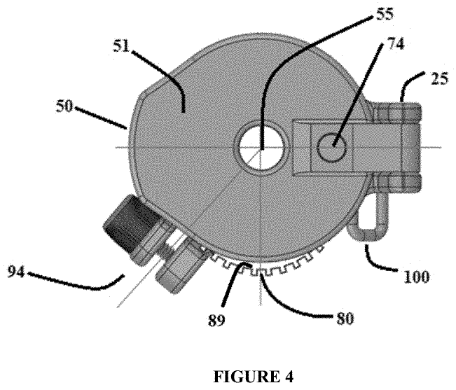

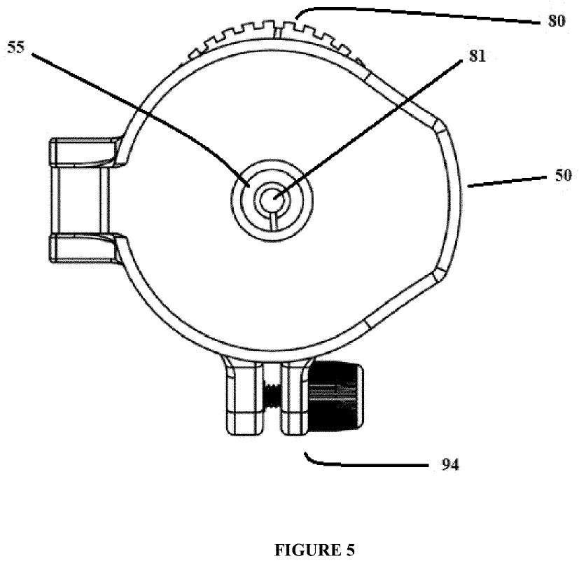

FIG. 4-5 illustrate top views of night vision refocus devices 1 in accordance with certain example embodiments. The engageable portion 89 of the ASC 80 is more clearly illustrated in these figures, which illustrate the ease with which the ASC may be accessed. FIGS. 4-5 each illustrate the faceplate-aperture, while FIG. 5 illustrates a first IFA 81 concentrically aligned with the faceplate-aperture. As also illustrated by FIGS. 4-5, the faceplate-aperture 55 may be located at a center point of the effective sight line covering portion of the faceplate 50. That is, the overall geometry of the faceplate may be larger than the circular area of an objective lens of an optical device but the portion of the faceplate that overlaps the circular area of the objective lens may be considered the effective sight line covering portion. In this regard, the faceplate-aperture may be concentrically located over a center point of the objective lens and/or at a center point of the effective sight line covering portion of the faceplate.

The night vision refocus devices may also include an aperture-selection component (ASC) rotatably mounted directly or indirectly to the faceplate. In accordance with certain example embodiments, the ASC may be rotatably mounted directly or indirectly to the inner surface of the faceplate, to the outer surface of the faceplate, or within a cavity defined by the faceplate. In this regard, the faceplate and the ASC may be mounted in a parallel to each other, such as face-to-face relative configuration in which the proximate or adjacent faces (e.g., surfaces) include respective positioning elements to define and/or retain fixed positioning states for the ASC. The ASC, for example, may include a plurality of individual refocusing-apertures (IFAs) including a first IFA having a first area and a second IFA having a second area, in which the first area is larger than the second area. As noted above, the ASC may comprise a varying number of IFAs, such as for example from at least about any of the following: 2, 3, 4, and 5, and/or at most about any of the following: 10, 9, 8, 7, 6, and 5, in which each IFA may have a unique diameter or area. Each IFA, for example, may independently from each other comprise a unique area having, for example, a unique diameter from about 2 mm to about 18, such as at least about any of the following: 2, 4, 6, 8, and 10 mm, and/or at most about any of the following: 18, 16, 14, 12, and 10 mm. In accordance with certain example embodiments, the first IFA may be aligned with the faceplate-aperture when the ASC component is oriented in a first position when the faceplate is in a closed state, and the second IFA may be aligned with the faceplate-aperture when the ASC is oriented in a second position and the faceplate is in a closed state. In accordance with certain example embodiments, the faceplate-aperture area may be larger than the second area, larger than the first area, or both. The faceplate-aperture area, in accordance with certain example embodiments, may be larger than each of the respective IFA areas. For example, the faceplate-aperture area may be larger than any of the areas defined by any of the IFAs. Alternatively, the faceplate-aperture area may be the same size as a largest area (or diameter) of a largest sized aperture of the ASC.

In accordance with certain example embodiments, each of the IFAs present in the ASC may be associated with its own unique fixed position in which each IFA is individually and repeatably aligned with the faceplate-aperture when the faceplate is in a closed state. In accordance with certain example embodiments, each of the IFAs present in the ASC may be associated with its own unique fixed position in which each IFA is individually and repeatably aligned with both the faceplate-aperture when the faceplate is in a closed state and an objective lens of an optical device.

As noted above, the ASC may be rotatably mounted directly or indirectly to the faceplate. For example, the ASC, in accordance with certain example embodiments, may be rotatable about an axle that is operably coupled to the inner surface of the faceplate, the outer surface of the faceplate, or within a cavity defined by the faceplate. The axle, for example, may be oriented perpendicular to the particular surface of the faceplate to which the ASC is mounted and/or located at an offset location relative to the faceplate-aperture. In accordance with certain example embodiments, the axle may be a separate component about which the ASC rotates and the axle may be rotatably mounted on or within a portion of the inner surface, outer surface, or within a cavity defined by the faceplate. In this regard, the ASC may be rotatably mounted indirectly to the inner surface of the faceplate, the outer surface of the faceplate, or within a cavity defined by the faceplate. Alternatively, the inner surface of the faceplate, the outer surface of the faceplate, or a cavity defined by the faceplate may comprise an integrally formed axle component about which the ASC rotates. In this regard, the ASC may be rotatably mounted directly to the inner surface of the faceplate, the outer surface of the faceplate, or a cavity defined by the faceplate.

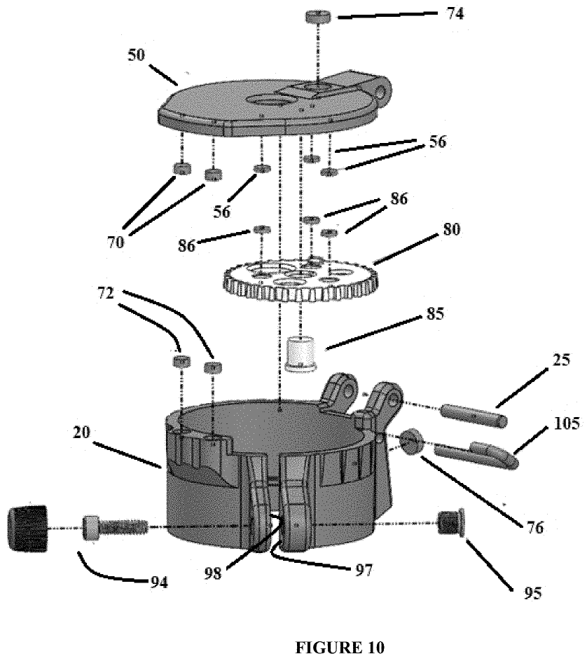

In accordance with certain example embodiments, the inner surface of the faceplate may include a plurality of faceplate-positioning elements (e.g., springs and detents, etc.) and the ASC may include a plurality of ASC-positioning elements, in which the plurality of faceplate-positioning elements mate (e.g., engage or interact) with the plurality of ASC-positioning elements to define a plurality of fixed position for the ASC, including for example the first position and the second position noted above. The plurality of faceplate-positioning elements, in accordance with certain example embodiments, may comprise a first group of positioning magnets housed by the faceplate and the plurality of ASC-positioning elements comprise a second group of positioning magnets housed by the ASC as best illustrated in FIG. 10, which is discussed in greater detail below. As noted above, the plurality of faceplate-positioning elements and/or the plurality of ASC-positioning elements may comprise elements other than magnets. For example, the inner surface of the faceplate and the ASC may comprise one or more detent assemblies (i) including one or more depressions located in the faceplate and one or more protuberances formed or incorporated within a first side of the ASC that is proximate or adjacent the depressions located in the faceplate or (ii) including one or more depressions located within a first side of the ASC that is proximate or adjacent the faceplate and one or more protuberances formed or incorporated within the faceplate.

FIGS. 6 and 7, for instance, illustrate night vision refocus devices 1 in an open state and illustrate an ASC 80 including a first IFA 81, a second IFA 82, and a third IFA 83, in which the first IFA 81 has the smallest area and the third IFA 83 has the largest IFA with second IFA 82 having an intermediate area. In this regard, the IFAs are oriented on the ASC 80 as a series of increasing or decreasing aperture sizes. For example, the second IFA 82 is bounded on each side by the first IFA 81, which has a smaller diameter or area, and the third IFA 83, which has a larger diameter or area. As illustrated by FIGS. 6 and 7, the ASC 80 is rotatably mounted to the inner surface 53 of the faceplate 50 by means of an axle 85 that extends through the ASC and engages the inner surface of the faceplate. As also illustrated by FIGS. 6 and 7, the faceplate 50 may comprise one or more first coupling elements 70 and the housing 20 may comprise one or more corresponding first coupling elements 72, in which first coupling elements 70, 72 mate or otherwise engage to releasably lock the faceplate 50 in a closed state in which the faceplate is adjacent and/or overlies the distal end 24 of the housing 20. The corresponding first coupling elements 70, 72 illustrated by FIGS. 6 and 7 may comprise magnets. As noted above, however, the corresponding first coupling elements may comprise other types of coupling elements (e.g., mechanically mating components, such as a male connector portion and a female connector portion) that provide releasable engagement such that the faceplate may be closed and held in the closed state until a user wishes to position the faceplate in the open state. As best illustrated in FIG. 2, the faceplate 50 and the housing 20 may comprise one or more second corresponding coupling elements 74 (e.g., housed within or on the faceplate), 76 (e.g., housed within or on the housing) that releasably lock the faceplate in an open state in which the faceplate does not overlie the distal end of the housing. The corresponding second coupling elements 74, 76 illustrated by FIG. 2 may comprise magnets. As noted above, however, the corresponding second coupling elements may comprise other types of elements (e.g., mechanically mating components, such as a male connector portion and a female connector portion) that provide releasable engagement such that the faceplate may be held in the open state until a user wishes to position the faceplate in the closed state.

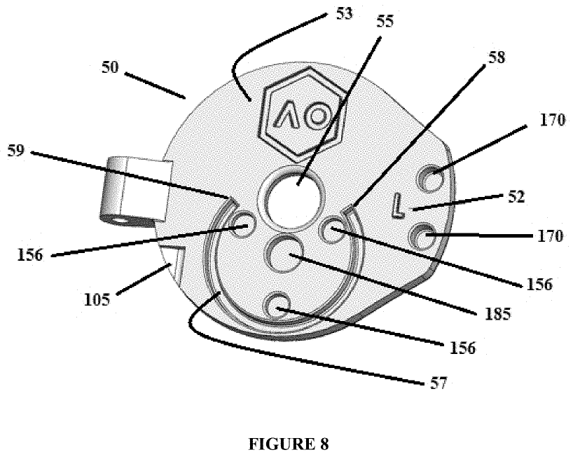

In accordance with certain example embodiments, the faceplate may include an arcuate groove formed therein (e.g., within the inner surface, within the outer surface, or within a cavity defined by the faceplate), and a first side of the ASC that is proximate or adjacent the arcuate groove of the faceplate may include a hard-stop projection configured to be slidably housed within the arcuate groove. In this regard the arcuate groove may include a first end associated with alignment of the smallest IFA with the faceplate aperture and second end associated with alignment of largest IFA with the faceplate aperture. Accordingly, a user may quickly rotate the ASC to one extreme or the other to quickly and easily identify the smallest and/or largest IFA for use with an optical device. FIG. 8, for example illustrates an inner surface 53 of a faceplate 50 in accordance with certain example embodiments. As illustrated by FIG. 8, the inner surface may include an arcuate groove 57 including a first end 58 and a second end 59. The faceplate 50 may also include an axle-housing portion 185 located in an offset manner from the faceplate-aperture 55. The inner surface 53 may also include hand or side indicator 52, a first group of housing compartments 156 configured for receiving the faceplate-positioning elements therein, and a second group of housing compartments 170 configured for receiving the ASC-positioning elements therein. The particular embodiment illustrated by FIG. 8 also includes an optional notched portion 105 that enables use of an optional locking wire 100 (as shown in FIG. 2). In this regard, the optional locking component 100 (e.g., a wire) directly or indirectly operably connected to the housing 20, in which the locking component directly or indirectly engages the faceplate 20 when the faceplate is in an open state and prevents the faceplate from moving into a closed state in which the faceplate is adjacent and overlies the distal end of the housing. For example, the optional locking component 100 may be directly or indirectly operably connected to the housing 20, wherein the locking component directly or indirectly engages the faceplate 50 when the faceplate is in an open state in which the faceplate does not overlie the distal end 24 of the housing and prevents the faceplate from moving into a closed state in which the faceplate is adjacent and overlies the distal end of the housing.

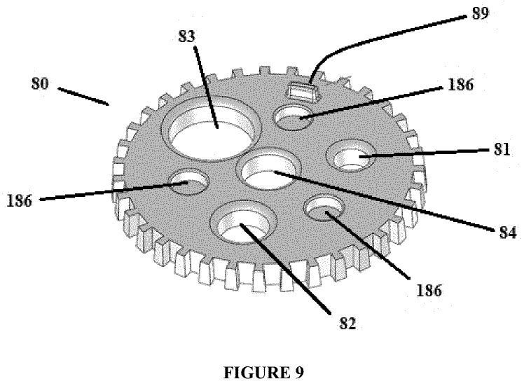

FIG. 9 illustrates a ASC 80 in accordance with certain example embodiments, in which the ASC includes a first IFA 81, a second IFA 82, and a third IFA 83. That ASC 80 may also include an axle-receiving orifice 84 through which an axle may be passed such that the ASC rotates about. The ASC 80 may also include a third group of housing-components configured for receiving the ASC-positioning elements therein. As additionally illustrated by FIG. 9, the ASC may include a hard-stop projection 89 configured to be slidably housed within the arcuate groove 57 of the faceplate 50. In this regard, the hard-stop projection 89 may slide from the first end 58 to the second end 59 of the faceplate 50.

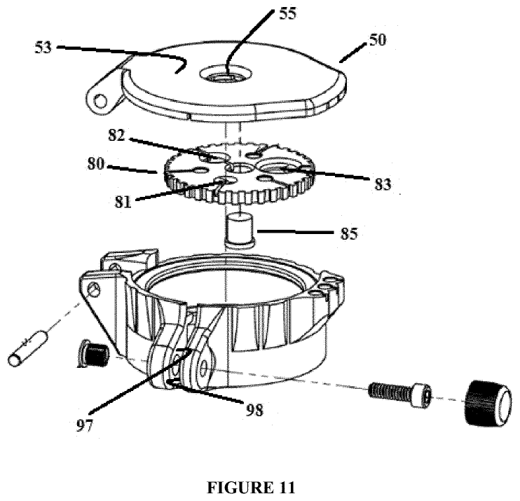

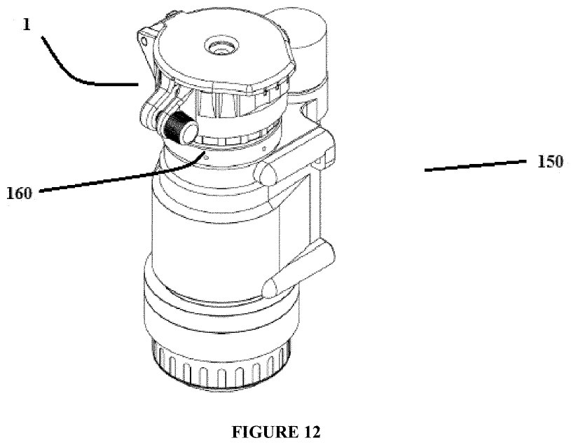

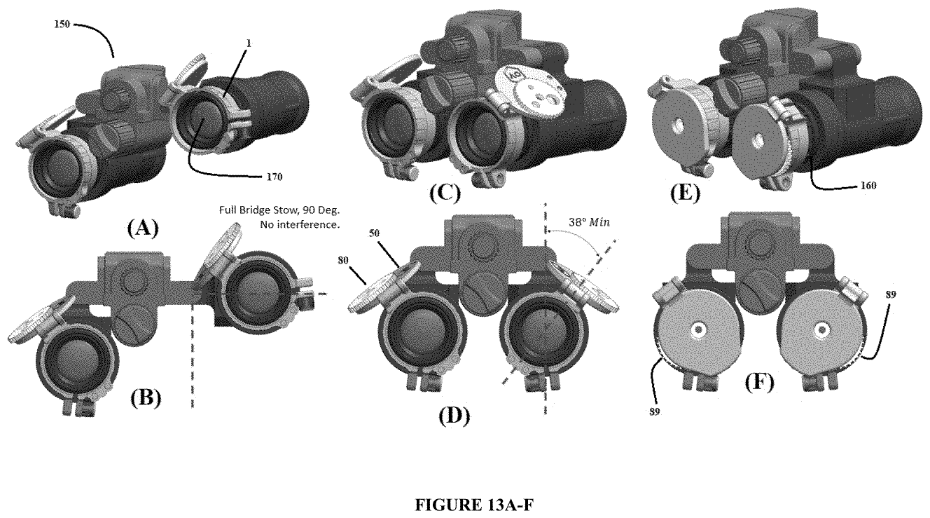

In accordance with certain example embodiments, the housing may comprise a first end extending from the proximate end to the distal end and a second end extending from the proximate end and the distal end to define a band clamp structure having a variable diameter upon tightening or loosening of one more clamping mechanisms passing through respective orifices of the first end and the second end. In this regard, the housing of the night vision refocus device may be mechanically clamped or locked on the lens frame of an optical device. FIGS. 10 and 11, for example, illustrate exploded views of the night vision refocus device 1. As shown in FIGS. 10 and 11, the housing 20 may include a first end 97 extending from the proximate end 22 to the distal end 24 and a second end 98 extending from the proximate end 22 and the distal end 24 to define a band clamp structure having a variable diameter upon tightening or loosening of one more clamping mechanisms 94, 95 passing through respective orifices of the first end and the second end. The exploded view of FIG. 10 also illustrates the relative alignment of each of the components forming the night vision refocus device 1, as well as the placement of faceplate-positioning elements (e.g., magnets) 56, and the ASC-positioning elements (e.g., magnets) 86. The particular embodiment illustrated in FIG. 10 includes an ASC comprising a circular disc.

In accordance with certain example embodiments, the night vision refocus device may include multiple ASCs, such as a first ASC and a second ASC each being directly or indirectly rotatably mounted to the inner surface of the faceplate, the outer surface of the faceplate, or within a cavity defined by the faceplate. In certain example embodiments, a first ASC may be mounted to the inner surface of the faceplate and a second ASC may be mounted to the outer surface of the faceplate. Alternatively, all of the ASCs may be mounted to the inner surface of the faceplate, the outer surface of the faceplate, or within a cavity defined by the faceplate. The multiple ASCs, in accordance with certain example embodiments, may be aligned along a common axis of rotation. In accordance with certain example embodiments, the first ASC may include a first group of IFAs defining first range of individual aperture areas and the second ASC may include a second group of IFAs defining a second range of individual aperture areas, wherein the first range of individual aperture areas and the second range of apertures do not overlap and are different. The multiple ASCs, for example, may be mounted parallel to each other along, for example, a common axle.

In accordance with certain example embodiments, the night vision refocus device may be devoid of a lens, such as a sacrificial lens. In this regard, the absence of any lens within the night vision refocus device prevents undesirable interference or negative impact to the optical clarity of an optical device that may be coupled to the night vision refocus device.

In accordance with certain example embodiments, the night vision refocus device may include a first IFA, in which the first IFA, the faceplate aperture, and a line of sight of a lens of an optical device are aligned in the first position of the ASC when the faceplate is in a closed state as disclosed and described herein. The night vision refocus device may include a second IFA having a different diameter or area than the first IFA, in which the second IFA, the faceplate aperture, and a line of sight of the lens of the optical device are aligned in the second position when the faceplate is in a closed state as disclosed and described herein.

In another aspect, the present invention provides an optical device, such as a night vision device, including a light-intensifying structure (e.g., an image intensifier or other device or structure that increases the intensity of available light in an optical system to allow use under lower-light conditions) and a night vision refocus device, such as those described and disclosed herein. The night vision refocus device may be permanently or releasably mounted to a lens frame (e.g., housing an objective lens) of the night vision device. As illustrated in FIG. 13, a night vision device 150 (e.g., a night vision monocular) includes a night vision refocus device 1 coupled to a lens frame 160 of the night vision device. Although FIG. 13 illustrates that night vision refocus device 1 being coupled or mechanically attached to the night vision device as an accessory item, the housing of the night vision refocus device and the lens frame may be integrally formed together as a unitary component in accordance with certain example embodiments. In such embodiments, the night vision refocus device may be considered to be a permanent feature of the night vision device.

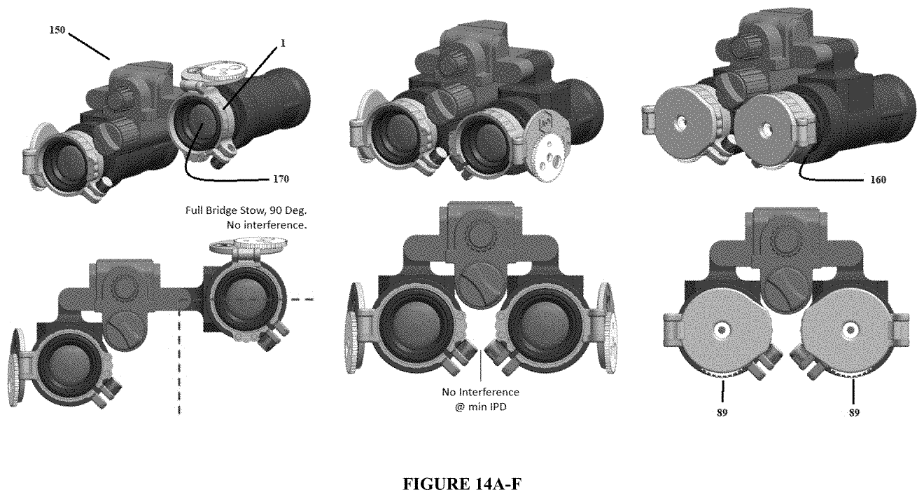

In accordance with certain example embodiments, the night vision device may comprise binoculars in which binoculars are temporarily or permanently coupled one or more night vision refocus devices. In this regard, the binoculars include multiple channel, in which a respective objective lens is present for each channel. FIGS. 13A-F and 14-F illustrated a pair of night vision binoculars including a pair of night vision refocus devices coupled thereto. In this regard, the left sight line of the night vision binoculars is associated with a left night vision refocus device and the right sight line of the night vision binoculars is associated with a right night vision refocus device. The left and right night vision refocus devices may be operated independently of each other. In accordance with certain example embodiments, the left and right night vision refocus devices may be mirrored with each other with respect to the orientation of rotation of the respective ASCs. That is, the left and right night vision refocus devices may be mirrored such that during use a user or operator may quickly rotate the ASC of both night vision refocus devices all the way, for example, in an identical direction (e.g., upward or downward) to quickly identify the same size IFA (e.g., the smallest area IFA or the largest area IFA) for both night vision refocus devices as illustrated in FIGS. 13A-F wherein the engageable portion 89 of the left and right night vision refocus devices is located in an outboard position. FIGS. 14A-F illustrate the left and right night vision refocus devices mounted to the night vision binoculars in a different orientation, such that the engageable portion 89 of each of the ASCs is located in an underneath or bottom location. In this regard, a user or operator may rotate both ASCs all the way in the same direction (e.g., outwardly or inwardly) to quickly identify the same size IFA (e.g., the smallest area IFA or the largest area IFA) for both night vision refocus devices as illustrated in FIGS. 14A-F.

In addition to the above, FIGS. 13A-F illustrate as worn clocking states of night vision refocus devices 1 coupled to a lens frame of a night vision device housing objective lens 170, in which the engageable portions of the ASC are each located in an outboard position in accordance with certain example embodiments. As also shown in FIG. 13A-F, the night vision refocus devices 1 do not interfere with the standard operation of the night vision binoculars 150, regardless of being in a closed state, an open state, or when one of the objective lens is rotated. FIGS. 14A-F illustrate as worn clocking states of a night vision refocus devices 1 coupled to a lens frame of a night vision device housing objective lens 170, in which the engageable portion of the aperture-selection component is located in an underside position in accordance with certain example embodiments. As also shown in FIG. 14A-F, the night vision refocus devices 1 do not interfere with the standard operation of the night vision binoculars 150, regardless of being in a closed state, an open state, or when one of the objective lens is rotated. In this regard, the clamping feature at the proximate end of the housing of the night vision refocus devices enable multiple mounting orientations such that the engageable portion of the ASC may be positioned at point of particular preference for a given user.

In accordance with certain example embodiments, the night vision device may comprise any form of night vision goggles (NVG), such as monoculars (PVS-14), binoculars (PVS-31), and Panoramic NVG's. In this regard, there may many variants of mono-, bino-, and pano-NVGs, but essentially the NVG may comprise a single channel or multiple channel NVG, such as a single channel, a dual channel, or a 4-channel NVG's.

These and other modifications and variations to the invention may be practiced by those of ordinary skill in the art without departing from the spirit and scope of the invention, which is more particularly set forth in the appended claims. In addition, it should be understood that aspects of the various embodiments may be interchanged in whole or in part. Furthermore, those of ordinary skill in the art will appreciate that the foregoing description is by way of example only, and it is not intended to limit the invention as further described in such appended claims. Therefore, the spirit and scope of the appended claims should not be limited to the exemplary description of the versions contained herein.

That which is claimed:

1. A night vision refocus device, comprising:
(i) a housing comprising a proximate end configured to couple to a lens frame of a night vision device and a distal end;
(ii) a faceplate operably connected to the housing, wherein the faceplate includes an outer surface, an inner surface, and a faceplate-aperture having a faceplate-aperture area;
(iii) an aperture-selection component (ASC) rotatably mounted directly or indirectly to the faceplate, wherein the ASC includes a plurality of individual refocusing-apertures (IFAs) including a first IFA having a first area and a second IFA having a second area, the first area being larger than the second area;
wherein the first IFA is aligned with the faceplate aperture when the ASC component is oriented in a first position, and the second IFA is aligned with the faceplate aperture when the ASC is oriented in a second position.

2. The device of claim 1, wherein the faceplate is connected to the housing via a hinge, wherein the faceplate has a closed state in which the faceplate is adjacent and/or overlies the distal end of the housing and an open state in which the faceplate does not overlie the distal end of the housing.

3. The device of claim 1, wherein the faceplate-aperture is located at a center point of the faceplate, and the faceplate-aperture area is larger than the second area, larger than the first area, or both.

4. The device of claim 3, wherein the ASC is rotatable about an axle that is operably coupled to the of the faceplate, the outer surface of the faceplate, or within a cavity of the faceplate, and wherein the axle is oriented perpendicular to the inner surface of the faceplate or the outer surface of the faceplate, and wherein the axle is located at an offset location relative to the faceplate-aperture.

5. The device of claim 4, wherein the inner surface of the faceplate, the outer surface, or the cavity of the faceplate includes a plurality of faceplate-positioning elements and the ASC includes a plurality of ASC-positioning elements, wherein the plurality of faceplate-positioning elements mate with the plurality of ASC-positioning elements to define a plurality of fixed position for the ASC, including the first position and the second position.

6. The device of claim 5, wherein the plurality of faceplate-positioning elements comprise a first group of positioning magnets housed by the faceplate and the plurality of ASC-positioning elements comprise a second group of positioning magnets housed by the ASC.

7. The device of claim 5, wherein the faceplate and the ASC are mounted in a parallel face-to-face relative configuration, and wherein the faceplate and the ASC comprise one or more detent assemblies (i) including one or more depressions located in the faceplate and one or more protuberances formed or incorporated within a first side of the ASC that is proximate or adjacent the depressions located in the faceplate or (ii) including one or more depressions located within a first side of the ASC that is proximate or adjacent the faceplate and one or more protuberances formed or incorporated within the faceplate.

8. The device of claim 1, wherein the faceplate includes an arcuate groove formed therein, and a first side of the ASC that is proximate or adjacent the arcuate groove of the faceplate includes a hard-stop projection configured to be slidably housed within the arcuate groove.

9. The device of claim 1, wherein the first IFA, the faceplate aperture, and a line of sight of the lens of the optical device are aligned in the first position when the faceplate is in a closed state in which the faceplate is adjacent and overlies the distal end of the housing, and wherein the second IFA, the faceplate aperture, and a line of sight of the lens of the optical device are aligned in the second position when the faceplate is in a closed state in which the faceplate is adjacent and overlies the distal end of the housing.

10. The device of claim 1, wherein an engageable portion of the ASC extends beyond the faceplate and housing and is directly engageable by a user to impart rotation of the ASC about the axle.

11. The device of claim 1, wherein the faceplate and the housing comprise one or more first corresponding coupling elements that releasably lock the faceplate in a closed state in which the faceplate is adjacent and/or overlies the distal end of the housing.

12. The device of claim 1, wherein the faceplate and the housing comprise one or more second corresponding coupling elements that releasably lock the faceplate in an open state in which the faceplate does not overlie the distal end of the housing.

13. The device of claim 1, wherein the housing comprises a first end extending from the proximate end to the distal end and a second end extending from the proximate end and the distal end to define a band clamp structure having a variable diameter upon tightening or loosening of one more clamping mechanisms passing through respective orifices of the first end and the second end.

14. The device of claim 1, further comprising a locking component directly or indirectly operably connected to the housing, wherein the locking component directly or indirectly engages the faceplate when the faceplate is in an open state in which the faceplate does not overlie the distal end of the housing and prevents the faceplate from moving into a closed state in which the faceplate is adjacent and overlies the distal end of the housing.

15. The device of claim 1, wherein the device is devoid of a sacrificial lens or other transparent protective cover.

16. The device of claim 1, wherein the ASC comprises from 2 to about 10 IFAs, wherein each IFA has a unique area.

17. The device of claim 1, wherein each IFA independently comprise a unique area having a unique diameter from about to about 2 to about 18 mm.

18. The device of claim 1, wherein the ASC comprises a circular disc.

19. A night vision device, comprising: an optical device and a night vision refocus device according to claim 1 being permanently or releasably mounted to a lens frame of the night vision device.

20. The night vision device of claim 19, wherein the housing of the night vision refocus device and the lens frame are integrally formed together as a unitary component.
